(19) United States
(12) Patent Application Publication
(10) Pub. No.: US 2009/0022048 A1
(43) Pub. Date: Jan. 22, 2009

(54) DATA RECORDING WRITE STRATEGY OPTIMISATION

(75) Inventors: Gerardus Rudolph Langereis, Eindhoven (NL); Erwin Rinaldo Meinders, Eindhoven (NL); Joachim Wilhelm Hellmig, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,502

(22) PCT Filed: Dec. 15, 2004
(86) PCT No.: PCT/IB04/52813

§ 371 Date: Jun. 15, 2006

(30) Foreign Application Priority Data
Dec. 22, 2003 (EP) 03104919.0

(51) Int. Cl. G11B 5/02

(52) U.S. Cl. 369/292; G9B/5.026

(57) ABSTRACT

The present invention relates to determining at least one write strategy, using a write strategy model comprising first and second parameters, for recording data on a recording medium comprising, providing at least one set of randomised first parameters, (102, step 202), writing at least one test data, 104, pattern by using said at least one set of first randomised first parameters, (102), (106, step 204), reading the recorded test data pattern, (108, step 206) and calculating a set of second parameters, (114),(112, step 208), based on said read test data pattern (110) and the at least one set of first randomised parameters, (102). From the calculated set of second parameters, (114) and the real data to be recorded, 118, sets of first parameters (120) are calculated, (step 210). The real data (118) are recorded (122, step 212) by using the chosen write strategy model.

### FIELD OF THE INVENTION

The present invention relates in general to recording of data on a recording medium, and in particular to data recording using a write strategy optimisation method.

### BACKGROUND OF THE INVENTION

There is a continuous demand for writing and reading techniques with an ever increasing data density.

The field of optical storage, which is the reproduction of data using a focused laser beam in a cheap replicatable medium, has proven to be a suitable technology for cheap content distribution. Also in this field an increase in data density is needed to meet the requirements of the ever growing size of video and data contents.

Various techniques have been proposed, of which two are the groove dye recording and the phase-change recording techniques. By applying the so called groove dye recording technique, which utilizes storage locations on a recording medium, or pits, that have not been mastered prior to the recording, or by using the so called phase-change recording technique, the recorder can not write marks into the storage locations, that are read by the reader as having a predetermined physical size. The reason to this is due to two phenomena of which one is due to thermal interference or cross talk between neighbouring storage locations on the recording medium, and the other is due to that the read-out signal is affected by optical interference or cross talk between storage locations, i.e. inter-symbol interference. These phenomena can not be distinguished in the read-out signal.

This means that upon storing a data block, a drive has to obtain or optimise a write strategy for writing the data, based on the read levels in the read-out signal, without knowing the exact physical size of the storage locations.

Upon decreasing the size of the storage locations, the mentioned thermal and optical interference become 2-dimensional. Storing data in for instance a hexagonal lattice there are six nearest-neighbour interfering cells.

In the case of nearest neighbour optical interference and storage of eight levels in each location there are 8⁶=262 144 combinations of neighbouring levels, corresponding to an equal number of write entries in a write strategy matrix.

As regard to optical interference, there is circle-symmetry, meaning that for optimising a certain storage location, only 8²=64 combinations of levels have to be evaluated.

However, for writing data, thermal interference needs to be considered.

In the case of thermal interference, four types of translative symmetry in a hexagonal lattice, is identified.

The first is the pre-heat from the previous mark in the track to the current mark. The thermal interference is the post-heat from a mark which is currently written, to the second previous mark. The other two interferences are cross-track interferences. There are two type: forward and backward, which are thermally different due to the rotation direction of the recording medium. These thermal interferences are only invariant to translations.

For phase change recording with reduced track pitches all four types of interferences have to be considered. For write once recording, the cross-track interferences are however heavily reduced.

It will thus be difficult to reduce the 8⁶ number of interferences.

This means that upon storing a data block, a drive has to obtain or optimise a write strategy for writing the data, based on the read levels in the read-out signal, without knowing the exact physical size of the storage locations.

In the document US2002/0126604, a write strategy for writing data is presented, which is based on a trial and error procedure, in which test data are written on a recording medium. The read response of the written data is compared with an expected response of said test data, as the response of test data from a fixed model. The error signal is fed back to the writer, that modified the writing, and this iterative loop continues until the error signal is sufficiently small, at which stage the data is written on the optical medium.

This method is hence an iterative process and is based on trial and error in the writing of test data without reducing the number of mark-mark combinations (hexagonals) to be optimised. In addition, all possible interferences have to be optimised separately in order to fill a complete write strategy matrix.

It would thus be advantageous with a non-iterative write strategy for writing data on a recording medium, which strategy is quick and produces reliable results based on an optimisation. Advantageously, this improved process should not be based on the exhaustive testing of all possible interferences, but should extrapolate the complete write strategy matrix from a representative subset of the interferences, in order to reduce consumed disc space and optimisation time.

### SUMMARY OF THE INVENTION

This invention is thus directed towards solving the problem of providing a non-iterative write strategy for writing data on a recording medium, which strategy is quick and produces reliable results based on an optimisation.

This is achieved by using a write strategy using non-iterative optimisation for recording data on a recording medium.

One object of the present invention is thus to provide write strategy using non-iterative optimisation for recording data on a recording medium.

According to a first aspect of the present invention, this object is achieved by a method for determining at least one write strategy, using a write strategy model comprising first and second parameters, for recording data on a medium comprising the steps:

providing at least one set of randomised first parameters,

writing a data pattern by using said at least one set of first randomised parameters,

reading the recorded data pattern, and

calculating a set of second parameters, based on said read pattern and based on the at least one set of first randomised parameters, for enabling recording data on said medium, in an optimised manner.

A second object of the present invention is thus to provide recording of data on recording medium, using a write strategy using non-iterative optimisation.

According to a second aspect of the present invention, this object is achieved by a method for recording data on a recording medium, utilising a write strategy model using first and second parameters, comprising:

providing the set of second parameters, where the set of second parameters has been obtained by writing a data pattern by using at least one set of randomised first parameters, reading the recorded data pattern and calculating the set of second parameters based on said read pattern,

calculating at least one set of first parameters, dependent on the set of second parameters and the data to be recorded, and

recording data in at least one storage location, based the sets of calculated first and second parameters, and the data to be recorded.

A third object of the present invention is to provide a recording medium on which data is non-iteratively recorded utilising a write strategy model.

According to a third aspect of the present invention, this object is achieved by a recording medium having a least one data block written in at least one storage location area on said medium, said at least one data block comprising a data pattern that has been written by using a method utilising a write strategy model comprising first and second parameters, wherein at least one set of first parameters is randomised, such that the recorded data pattern can be read and the set of second parameters can be calculated based on said read pattern.

A fourth object of the present invention is to provide a device for determining of a write strategy for recording data on a recording medium in an optimised manner.

According to a fourth aspect of the present invention, this object is achieved by a write strategy determining device, for recording data on a recording medium, comprising:

a control unit, arranged to provide at least one set of randomised first parameters,

a writing unit, connected to the control unit, arranged to write a data pattern on said recording medium by using said at least one set of first randomised parameters,

a reading unit, connected to the control unit, arranged to read said recorded data pattern from said recording medium,

wherein said control unit further is arranged to calculate a set of second parameters, based on said read pattern and based on the at least one set of randomised first parameters.

A fifth object of the present invention is to provide a device for recording data on a recording medium utilising a write strategy model.

According to a fifth aspect of the present invention, this object is achieved by using first and second parameters, comprising:

a control unit, arranged to provide a set of second parameters, where the set of second parameters has been obtained by writing a data pattern by using at least one set of randomised first parameters, reading the recorded data pattern and calculating the set of second parameters based on said read pattern, and arranged to calculate at least one set of first parameters, dependent on the set of calculated second parameters and the data to be recorded, and

a writing unit, connected to the control unit, arranged to record data in at least one storage location on said recording medium, based on the sets of calculated first and second parameters and the data to be recorded.

The present invention has the following advantages:

It provides a write strategy for recording data on an recording medium requiring a limited set of test recordings only, to be able to calculate the set of second parameters.

It further provides a non-iterative and quick recording of data on the recording medium.

Direction of the independent claims and the advantages thereof:

Claim 2 is directed toward calculating at least one set of first parameters, based on the set of calculated second parameters and the data to be recorded.

Claim 3 is directed toward recording data in at least one storage location, based on the sets of calculated first and second parameters, and the data to be recorded.

This claim has also the advantage of that the recording of data on a recording medium is non-iterative and quick.

Claims 4, 5, 6, 7 and 8 are directed toward specifying the nature of first and second parameters, wherein the first parameters are write strategy parameters, wherein the write strategy parameters at least relate to write power levels, wherein the set of second parameters are strategy model parameters, wherein the set of second parameters are related to the read out level of the at least one storage location and the write power levels used, and wherein the read out level of the at least one storage location is linearly dependent on the write power levels used.

These claims have the advantage that an optimising of parameters related to write power levels is enabled. They are have the advantage of relating to both thermal interference during writing of data and optical interference during reading of data. Moreover, they have the advantage of enable the limiting of the number of required test recordings for the determination of the set of second parameters.

Claim 9 is directed toward specifying that the determining of the at least one write strategy is an optimisation.

This claim has the advantage that the write strategy calculated using the method is optimised.

Claim 10, 11 and 12 are directed toward the influences from marks at neighbouring storage locations, wherein the model is based on an influence on a certain storage location from processing neighbouring storage locations, wherein the write power level for storing data at a certain location is dependent on the write power levels used for neighbouring storage locations, and wherein the write power level for storing data at a certain location is dependent on the read out level at neighbouring storage locations.

These claims have the advantage that they enable recording at interfering storage locations.

These and other aspects of the invention will be apparent from and elucidated with reference to the embodiments described hereinafter.

### BRIEF DESCRIPTION OF THE DRAWINGS

The present invention will be more clearly understood from the following description of the preferred embodiments of the invention read in conjunction with the attached drawings, in which:

FIG. 1 presents a schematic illustration of a method for recording data on a recording medium, according to one embodiment of the present invention;

FIG. 2 shows a flow-chart of a method for recording data on a recording medium, according to a preferred embodiment of the present invention;

FIG. 3 shows a write strategy determining device for recording data on a recording unit, according to a preferred embodiment of the present invention; and

FIG. 4 shows a recording device using a write strategy model for recording data on a recording unit, according to a preferred embodiment of the present invention

FIG. 5 shows a recoding medium according to a preferred embodiment of the present invention.

### DESCRIPTION OF PREFERRED EMBODIMENTS

The present invention relates to in general to recording of data on a recording medium, for instance in the form of an optical disc, and in particular to data recording using a write strategy optimisation method.

As the distance of storage locations decreases the interference between neighbouring storage location increases both during the recording process and during the reading process.

By applying a strategy model in the write strategy method, a rapid recording of data, optimised as regard to the power used for writing data, the amplitude of the stored marks at the storage locations and the timing of the stored data, can be achieved.

According to one embodiment of the present invention, a write strategy model is provided comprising first parameters, L, for example write strategy parameters that are related to the writing power used, second parameters, alpha, for example write strategy model parameters that are related to said first parameters, and output levels, M, that are readable from the recording medium, of for instance the type optical disc.

A write strategy optimisation is proposed using a linearised model for the relation between write strategy and read-out level. By using this model, it can be calculated how to write data, that is which write strategy parameters to use, in order to be able to read the stored data, as the intended data to be stored. The calculation is based on a set of interference parameters, relating the read out level and the write strategy parameters used. These interference parameters are calculated from a limited number of test experiments, using randomised write strategy parameters. By applying a linearised model the number of experiments needed to solve a complete write strategy matrix can be reduced.

Consider the strategy needed to write at storage location “n”. In case only a preceding location “n−1” is affecting the storage location “n”, a first order model would look like

M(n)=L(n)+α·L(n−1),

### Wherein,

M(n) is the read-out level of storage location “n”,

L(n−1) is the write strategy parameter of the previous storage location “n−1”,

L(n) is the write strategy parameter of the current storage location “n”, and

α, is the interference parameter.

Returning to the thermal interference in the haxagonal lattice, the four types of thermal interferences can be implemented as noted below. If the mark at storage location “n” in track “m” has the read out level M(m,n), then the four thermally interfering marks are:

### a) L(m,n−1)

### b) L(m,n+1)

c) L(m+1,n−½)
d) L(m+1,n+½)
wherein c) and d) are from the next track and therefore shifted by either −½, or + 1/2, since the lattice is hexagonal.

Optical interference is induced by the same four thermally interfering marks, but also observed from neighbouring marks L(m−1,n−½) and L(m−1,n+½), that is observed from marks written in the following track. The model for hexagonal systems therefore becomes:

$$M ( m , n ) = L ( m , n ) + {α}_{1} \cdot L ( m , n - 1 ) + {α}_{2} \cdot L ( m , n + 1 ) + {α}_{3} \cdot L ( m + 1 , n - 1 / 2 ) + {α}_{4} \cdot L ( m + 1 , n + 1 / 2 ) + {α}_{5} \cdot L ( m - 1 , n - 1 / 2 ) + {α}_{6} \cdot L ( m - 1 , n + 1 / 2 ) , \qquad ( 1 )$$

wherein α₁ to α₆ are inference parameters.

Referring to the linearisation, there are two options of linearised models. In the first parameters α₁ to α₆ are assumed to be fixed for all marks L(m,n). The second more accurate linearisation, is a piece-wise linear model for which each level has it's own set of α₁ to α₆ parameters.

As mentioned above, thanks to using a linearised model, the number of test experiments, in order to calculate the interference parameters, can be reduced. Thus, all possible mark combinations need not to be tested. For N levels and M interfering marks, the number of entries in the write strategy look-up table equal N^{M+1}. Full linearisation only requires M+1 experiments and a piece-wise model only N·(M+1). The parameters for these experiments should however be chosen carefully in a random manner.

For the calculation of coefficients from the experiments, regression techniques are used. In, for instance, a six parameter model of equation (1) with P measurements on several randomly chosen levels, the equation to solve becomes:

M=L·α (2)

wherein
M is a p-dimensional column vector,
L is a p×i-dimensional matrix, and
α is an i-dimensional column vector.

The equations for the six parameter, for which i=7, thus become:

$$[ \begin{matrix}{M ( \text{?} )}_{1} \\ {M ( \text{?} )}_{2} \\ ⋮ \\ {M ( \text{?} )}_{P}\end{matrix} ] {{=}_{n}}^{{n}^{n}} [ \begin{matrix}, \text{?} ( ) n 1 ( {L}_{1} - \text{?} ) n ( + 1 L {}_{1} m ) + 1 n ( L , - m \text{?} ) \text{?} ( L \text{?} \frac{1}{2} \text{?} ) 1 \text{?} {( m , - n \frac{1}{2} )}_{1} L 1 - {( m , n + \frac{1}{2} )}_{1} \\ , \text{?} ( ) n 1 ( {L}_{2} - \text{?} ) n ( + 1 L {}_{2} m ) + 1 n ( L , - m \text{?} ) \text{?} ( L \text{?} \frac{1}{2} \text{?} ) 1 \text{?} {( m , - n \frac{1}{2} )}_{2} L 1 - {( m , n - \frac{1}{2} )}_{2} \\ ⋮ ⋮ ⋮ ⋮ ⋮ ⋮ ⋮ \\ , \text{?} ( ) n 1 ( {L}_{P} - \text{?} ) n ( + 1 L {}_{P} m ) 1 + n ( L , - m \text{?} ) \text{?}\end{matrix} ] [ \begin{matrix}1 \\ {α}_{1} \\ {α}_{2} \\ {α}_{3} \\ {α}_{4} \\ {α}_{5} \\ {α}_{6}\end{matrix} ] \\ \text{?} \text{indicates text missing or illegible when filed}$$

The M is thus a column vector with measured read out levels, L the matrix with applied strategy power settings and α the column vector with the interference parameters, αᵢ of interest. The column vector α can be estimated by calculating â, by

â=(L^{T}L)⁻¹L^{T}·M (3)

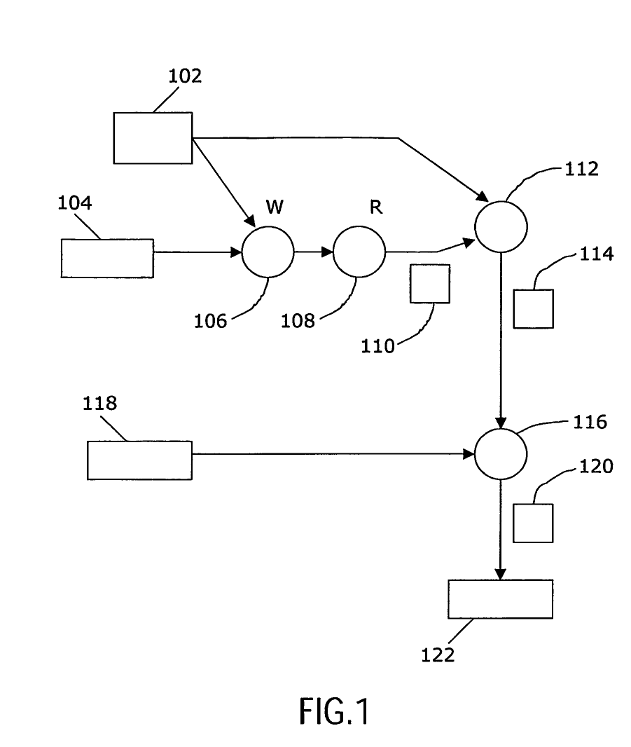

The step of determining the model parameters, alpha will now be explained with reference to FIG. 1, presenting a schematic illustration of recording data on a recording medium, by using a strategy model, according to one embodiment of the present invention.

Determining model parameters relies on writing test data patterns by using randomised first parameters, that is by applying randomised power levels, using a randomised set of initial write strategy parameters, 102, L₀. FIG. 1, schematically shows that the test data, 104, first are written, 106, after which the written data patterns are read, 108, thus obtaining test data read out levels, 110, M₀. Based on the model chosen, relating the M vector, the L matrix and the α vector, an estimation of the α vector, 114, is calculated, 112, using the randomised L₀-values, 102, and the corresponding read out M₀-values, 110. These calculated second parameters, the αᵢ values of the α vector, 114, reflect the interference between neighbouring storage locations.

Returning to equation (1),

M=L·α (1)

we note that we have estimated the column vector α as â, from the read out levels M, and the randomised L matrix.

By letting the M now represent the read data that we would like to read after having written data at the respective storage locations, and by using the calculated a vector, the L matrix can be calculated.

With reference again to FIG. 1, we note that based on the calculated second parameters, that is the α vector, 114, and the real data, 118, that we would like to record, the first parameters, that is the write strategy parameters, or the L matrix, 120, are calculated, 116, by applying the model. Having defined the L matrix, 120, for the real data set, 118, the data can thus be written, 122.

The calculation of the L matrix needs a further explanation.

In for instance a simple case in which the neighbouring interference in restrict to only next- and previous storage location interference, without interference from neighbouring tracks, the model would for instance look like this:

M(n)=L(n)+α₁·L(n−1)+α₂·L(n+1) (4)

The M(n) is the desired level of the current storage location, and the L(n−1) the write parameter used in the previous storage location. The L(n+1) is however the write parameter that is used in the next storage location. This parameter has not yet been determined as the current location is “n”.

In order to solve this complication, equation (4) can be used and written as

M(n+1)=L(n+1)+α₁·L(n)+α₂·L(n+2) (5).

### From (5)

L(n+1)=M(n+1)−α₁·L(n)−α₂·L(n+2) (6).

As regard to interferences, by respecting only the nearest neighbour interferences, that is disregarding higher order of interferences such as second- or third nearest neighbour interferences, the term α₂·L(n+2)=0, in (4). This implies that written marks at storage locations at most one location away from the current location is respected in this particular model.

By setting α₂·L(n+2)=0, an expression of L(n+1) as a function of L(n+1) and L(n) can be incorporated in equation (5) and L(n) calculated as

L(n)=[M(n)−α₁·L(n−1)−α₂·M(n+1)]/(1−α₁α₂) (7).

The write strategy to be used at storage location “n” in order to read M(n) at that location, is thus dependent on the write strategy of the previous mark at the previous storage location and the desired read out level at the following storage location, n+1, M(n+1).

This means that knowledge about the following data mark is required in order to write a mark at the current storage location. Having a data file, this means that the entire data file requires to be processed before the process of writing data at the first storage location can begin.

By processing the entire data amount to be stored on the recording medium, for instance an optical disc, before starting the writing process, the writing rate is enhanced as compared to processes relying on iterative calculations.

The determination of write strategy parameters and the process of writing data will be described below.

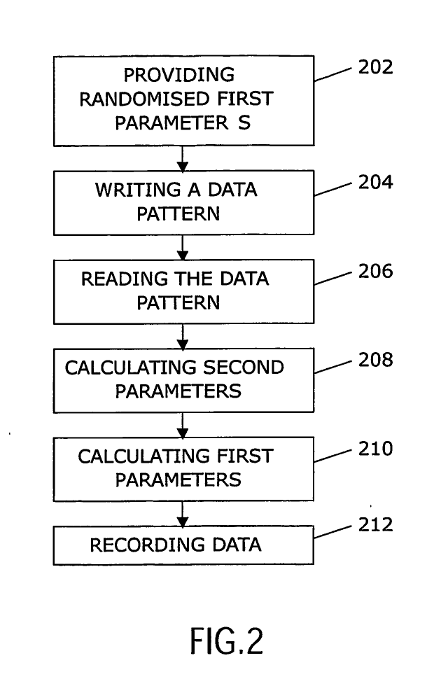

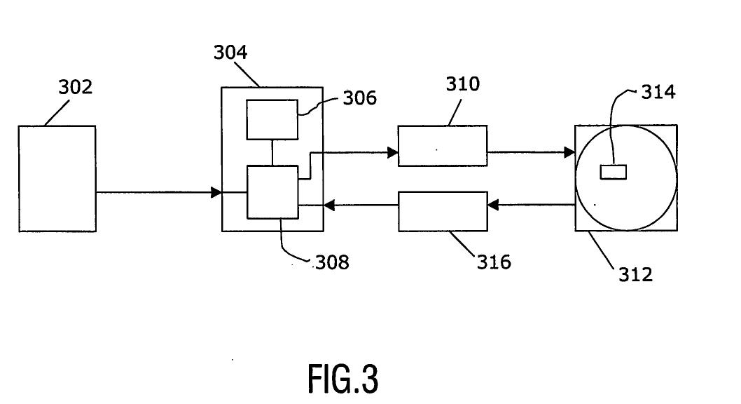

With reference to FIG. 2, showing a flow-chart of the method for recording data on a recording medium, according to a preferred embodiment of the present invention, and FIG. 3, showing a write strategy determining device for recording data on the recording medium, according to the preferred embodiment of the present invention, one aspect of the present invention will be explained in more detail. This aspect relates to determining of the write strategy used for recording data on said optical medium.

According to a preferred embodiment of the present invention, a write strategy determining device, as shown in FIG. 3, comprises a control unit, 304, said control unit comprising a randomising unit, 306, and a calculating unit, 308, a model unit, 302, for providing a model to calculating unit, 308, to which it is connected, a writing unit, 310 and a reading unit, 316, both of which being connected to the calculating unit, 308, and arranged to write data to a data block, 314, and read data from a data block, 314, respectively, of a recording medium, 312.

The method of determining the write strategy for recording data on a recording medium starts by providing randomised set of first parameters, step 202, to the calculating unit, 308, of the control unit, 304. The randomising unit, 306, thus randomises a set of first parameters provided by the model unit, 302. Upon having obtained randomised first parameters inside the control unit, 304, the step of writing a data pattern, step 204, on a recording medium, 312, is performed by the writing unit, 310. Typically, data is written in a data block, 314, on the recording medium, 312. Afterwards, reading of the written data pattern, step 206, of the recording medium, 312, takes place and is performed by the reading unit, 316. The read out data pattern stored in the data block, 314, of the recording medium, 312, read by the reading unit, 316, is then sent to the calculating unit, 308, of the control unit, 304, in which the step of calculating of second parameters, step 208, takes place. These second parameters are calculated from the randomised first parameters and the read out levels, obtained by the reading unit, 316, based on the model provided by the model unit, 302. Strategy model parameters, alpha, are hence obtained.

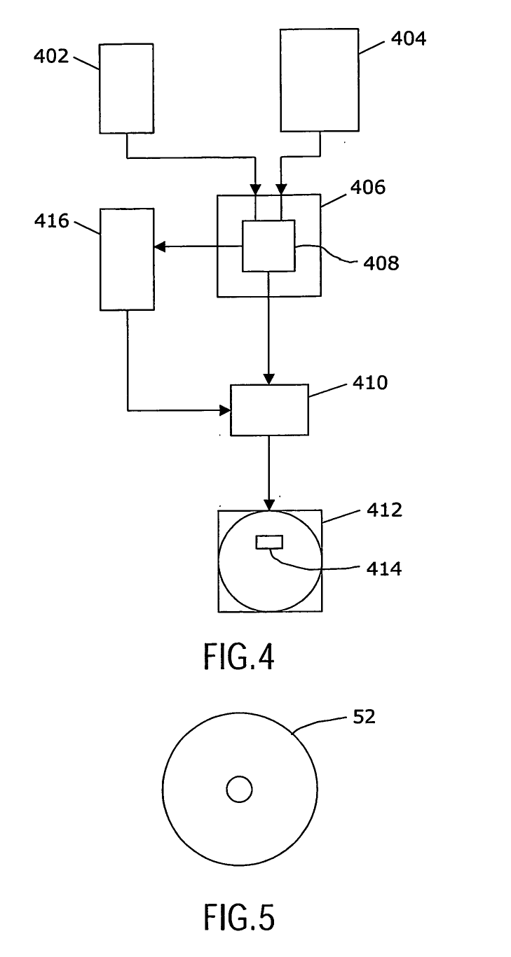

With reference to FIG. 2, and FIG. 4, showing a recording device using the write strategy model for recording data on the recording medium, according to the preferred embodiment of the present invention, another aspect of the invention will be explained in more detail. This aspect relates to recording data on an optical medium, by using the write strategy model.

According to a preferred embodiment of the present invention, a recording device, as shown in FIG. 4, comprises a control unit, 406, a model unit, 402, and a data unit, 404, both of which are connected to a calculating unit, 408, of the control unit, 406, a parameter memory unit, 416, connected to said calculating unit, 408, and a writing unit, 410, connected to both the calculating unit, 408, and the parameter memory unit, 416. The writing unit, 410, is further arranged to write data within a data block, 414, on a recording medium, 412, of the type of an optical disc, for instance.

The method of recording data on a recording medium starts by providing a set of second parameters, to the calculating unit, 408, of the control unit, 406. The set of second parameters are based on a model provided by the model unit, 402. Based on all the data to be recorded, provided by the data unit, 404, a set of first parameters are calculated by the calculating unit, 408. The calculated first parameters are stored in a parameter unit, 416, to be used in the step of recording the data. Having calculated the first parameters, step 210, and having earlier obtained the second parameters, step 210, recording the data on the recording medium, 412, in data blocks, 414, by the writing unit, 410, takes place, step 212.

Thus the data stored in the data unit, 404, are recorded on the recording medium, 412, by using the write strategy as calculated, step 208, for the model provided by the model unit, 402.

FIG. 5 shows a recording medium. According to one preferred embodiment of the present invention the recording medium is an optical disc.

The invention can be varied in many ways, for instance:

In a different embodiment of the present invention, a model is used in which interference from marks in neighbouring tracks is taken into account.

In another embodiment another model can be used, taking into account the second nearest neighbour effect, and thus disregarding only higher orders of neighbouring effects, such as third nearest neighbouring effect.

In a yet another embodiment of the present invention, the device for determining of write strategy parameters and the device for recording data, is preferably provided in the same entity, but can also be provided separately.

In still yet another embodiment of the present invention the number of levels of each mark at the storage locations, is different from 8, for instance 4, 12 or 16, to mention a few.

In still yet another embodiment of the present invention, the optimisation of write strategy matrix for non-iterative recording, is also applicable for runlength limited codes, intended to read out with partial response detection, having non-fixed cell sizes.

1. Method for determining at least one write strategy, using a write strategy model comprising first and second parameters, for recording data on a medium comprising the steps:
providing at least one set of randomised first parameters, (step 202),
writing a data pattern by using said at least one set of first randomised parameters, (102, 106, step 204),
reading the recorded data pattern, (108, step 206), and
calculating a set of second parameters, (112, 114, step 208), based on said read pattern (110) and based on the at least one set of first randomised parameters (102), for enabling recording data on said medium, in an optimised manner.

2. Method for determining at least one write strategy according to claim 1, further comprising the steps:
providing the set of calculated second parameters, (114), and
calculating at least one set of first parameters, (120, 116, step 210), based on the set of second parameters, (114) and the data to be recorded (118).

3. Method according to claim 2, further comprising the step:
recording data in at least one storage location, (step 212), based on the sets of calculated first and second parameters, (114, 120) and the data to be recorded (118).

4. Method according to claim 1, in which the parameters in the set of first parameters (102, 120), are write strategy parameters.

5. Method according to claim 1, in which the write strategy parameters (102, 120), at least relate to write power levels.

6. Method according to any one of claims 1, in which the parameters in the set of second parameters, (114), are strategy model parameters.

7. Method according to claim 1, in which the parameters in the set of second parameters, (114), are related to the read out level, (110), of the at least one storage location and the write power levels used, (102).

8. Method according to claim 7, in which the read out level, (110), of the at least one storage location is linearly dependent on the write power levels used, (102).

9. Method according to any one of claims 1, in which the determining of the at least one write strategy is an optimization.

10. Method according to claim 1, wherein the model is based on an influence on a certain storage location from processing neighbouring storage locations.

11. Method according to claim 10, wherein the write power level for storing data at a certain location is dependent on the write power levels used for neighbouring storage locations.

12. Method according to claim 10, wherein the write power level for storing data at a certain location is dependent on the read out level at neighbouring storage locations.

13. A method for recording data on a recording medium, utilising a write strategy model using first, (102, 120), and second parameters, (114), comprising:
providing the set of second parameters, where the set of second parameters (114), has been obtained by writing a data pattern (106, step 204) by using at least one set of randomised first parameters, (102, step 202), reading the recorded data pattern, (108, step 206), and calculating the set of second parameters (114) based on said read pattern, (110, step 208),
calculating at least one set of first parameters, (116, step 210), dependent on the set of second parameters, (114), and the data to be recorded, (118), and recording data (122, step 212), in at least one storage location, based the sets of calculated first, (120), and second parameters, (114), and the data to be recorded.

14. A recording medium, (52, 312, 412), having at least one data block, (314, 414), written in at least one storage location area on said medium, (52, 312, 412), said at least one data block, (314, 414), comprising a data pattern that has been written by using a method utilising a write strategy model comprising first, (102, 120), and second parameters, (114), wherein at least one set of first parameters, (102), is randomised, such that the recorded data pattern, (110), can be read, (108), and the set of second parameters, (114), can be calculated, (112), based on said read pattern, (110).

15. Write strategy determining device, for recording data, (step 212), on a recording medium, (52, 312, 412), comprising:
a control unit, (304), arranged to provide at least one set of randomised first parameters, (102),
a writing unit, (310), connected to the control unit, (304), arranged to write a data pattern, (106), on said recording medium, (52, 312, 412), by using said at least one set of first randomised parameters, (102),
a reading unit, (316), connected to the control unit, (304), arranged to read said recorded data pattern, (108, 110), from said recording medium, (52, 312, 412), wherein said control unit, (304), further is arranged to calculate, (112), a set of second parameters, (114), based on said read pattern, (110), and based on the at least one set of randomised first parameters, (102).

16. Recording device, for recording data (step 212), on a recording medium, (52, 312, 412), utilising a write strategy model using first, (120), and second parameters, (114), comprising:
a control unit, (406), arranged to provide a set of second parameters, (114), where the set of second parameters (114), has been obtained by writing a data pattern (step 204, 106) by using at least one set of randomised first parameters, (102), reading (step 206, 108), the recorded data pattern (110), and calculating (step 208, 112), the set of second parameters, (114), based on said read pattern, (110), and arranged to calculate (step 210, 116), at least one set of first parameters, (120), dependent on the set of calculated second parameters, (114), and the data to be recorded, (118), and
a writing unit, (410), connected to the control unit, (406), arranged to record data, (step 212, 122), in at least one storage location on said recording medium, (52, 312, 412), based on the sets of calculated first, (120), and second parameters, (114), and the data to be recorded, (118).
